(19) United States
(12) Patent Application Publication
(10) Pub. No.: US 2010/0324770 A1
(43) Pub. Date: Dec. 23, 2010

(54) TRAILER HITCH ALIGNMENT DEVICE AND METHOD

(75) Inventors: J. Edward Ramsey, Bristol, IN (US); John S. Betts, Woodstock, IL (US); James D. Lark, West Bloomfield, MI (US); Brian A. Mount, Shelby Township, MI (US); Robert J. Newton, Chesterfield, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignees: J. Edward Ramsey, Bristol, IN (US); John S. Betts, Woodstock, IL (US)

(21) Appl. No.: 12/666,926

(22) PCT Filed: Jul. 2, 2008
(86) PCT No.: PCT/US08/69038

§ 371 Date: Dec. 28, 2009

Related U.S. Application Data
(60) Provisional application No. 60/947,808, filed on Jul. 3, 2007.

(51) Int. Cl. G06F 19/00

(52) U.S. Cl. 701/25; 701/28

(57) ABSTRACT

A method of assisting a driver in aligning a vehicle hitch with a trailer hitch and electronic trailer alignment system includes providing a stereoscopic-imaging system and positioning the imaging system at one of the vehicle hitch or the trailer hitch. The imaging system includes at least two image sensors. At least two different images of a surface at the other of the vehicle hitch or the trailer hitch are captured with the at least two image sensors. Position data is captured from the at least two different images of the surface at the other of the vehicle hitch or the trailer hitch. The position data defines a position of the other of the vehicle hitch or the trailer hitch with respect to the one of the vehicle hitch or the trailer hitch. Steering data that will cause the vehicle hitch to approach the position of the trailer hitch is determined.

### CROSS REFERENCE TO RELATED APPLICATION

This application claims priority from U.S. application Ser. No. 60/947,808, filed on Jul. 3, 2007, the disclosure of which is hereby incorporated herein by reference in its entirety.

### BACKGROUND OF THE INVENTION

The present invention relates generally to trailer locating devices and, more specifically, it relates to a trailer hitch alignment system for assisting a user to align a hitch of a vehicle with a trailer hitch.

Users of trailers often have great difficulty in aligning their vehicle's hitch with the trailer hitch of a conventional trailer. A conventional trailer has a plurality of wheels rotatably supporting a frame and a trailer hitch for removably coupling with a vehicle that will be towing the conventional trailer. The user must align the hitch of the vehicle with the raised trailer hitch. This is extremely difficult since the hitch is usually out of viewing because of its location upon the vehicle's bumper. Generally, two persons are required to effectively and efficiently align the vehicle hitch with the trailer hitch. However, when the user is trying to align the hitches alone, the user must then slowly back up to the trailer hitch so as to prevent damage to the vehicle and trailer, stop the vehicle, exit the vehicle, view the position of the hitch relative to the trailer hitch to prevent damage to the trailer hitch and/or the vehicle, and then reenter the vehicle to repeat the process. This process is then generally repeated numerous times until the vehicle hitch and trailer hitch align. Hence, there is a need for a trailer hitch alignment system that allows a user to conveniently and precisely align a vehicle hitch with a trailer hitch without the user having to repeatedly exit the vehicle.

The repeated exiting and entering the vehicle is undesirable to users. In addition, the constant exiting and entering of the vehicle is time consuming and potentially dangerous. Mother issue is the inevitable likelihood of vehicle or trailer damage during attempts for trailer hitch alignment.

Devices presently in the art for trailer hitch alignment include systems utilizing cameras that are attached to the rear of the vehicle and display in the passenger compartment a view of the vehicle trailer hitch. Other devices include systems with mirrors mounted to provide a view of the vehicle's hitch. These systems are often expensive, inconvenient, and cumbersome to use.

These and other objects, advantages and features of this invention will become apparent upon review of the following specification in conjunction with the drawings.

### BRIEF DESCRIPTION OF THE DRAWINGS

FIG. 1 is a side elevation view of an electronic trailer hitch alignment system according to an embodiment of the invention applied to a vehicle and trailer;

FIG. 2 is a side elevation of a trailer hitch with a sensor applied thereto;

FIG. 3 is a top plan view of the trailer hitch in FIG. 2;

FIGS. 4a-4c are perspective views of a vehicle hitch with a visible target applied to the vehicle hitch;

FIGS. 5a-5d are perspective views of an alternative embodiment of a visible target;

FIGS. 6a-6c are perspective views of another alternative embodiment of a visible target;

FIG. 7 is a block diagram of a control system according to an embodiment of the invention;

FIG. 8 is a diagram illustrating stereoscopic image processing;

FIG. 9 is a flowchart of a method of assisting a driver in aligning a vehicle hitch with a trailer hitch; and

FIG. 10 is a perspective view of a driver interface module.

### DESCRIPTION OF THE PREFERRED EMBODIMENT

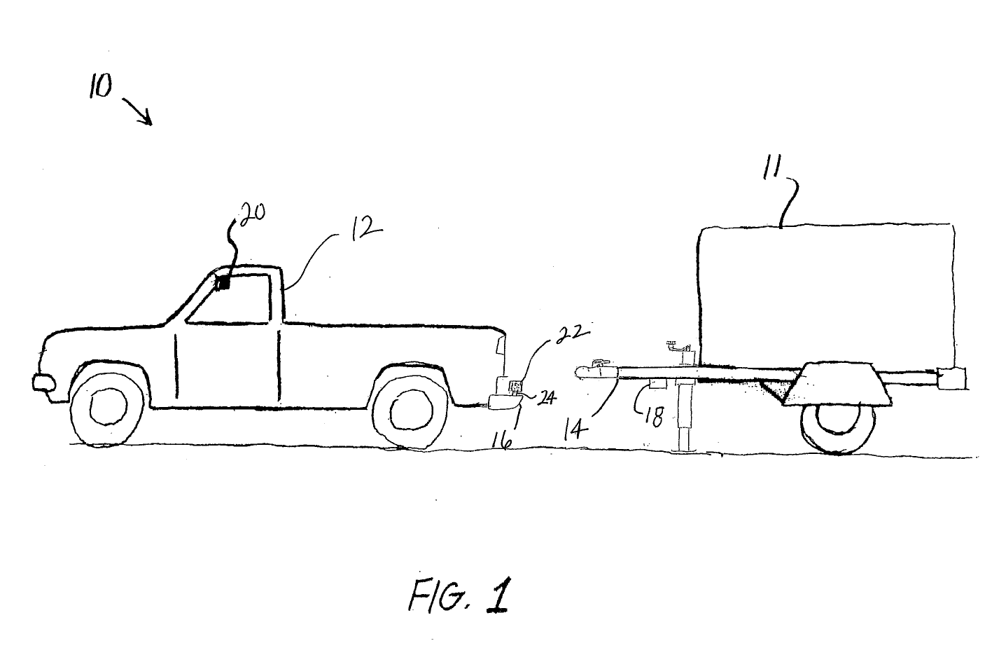

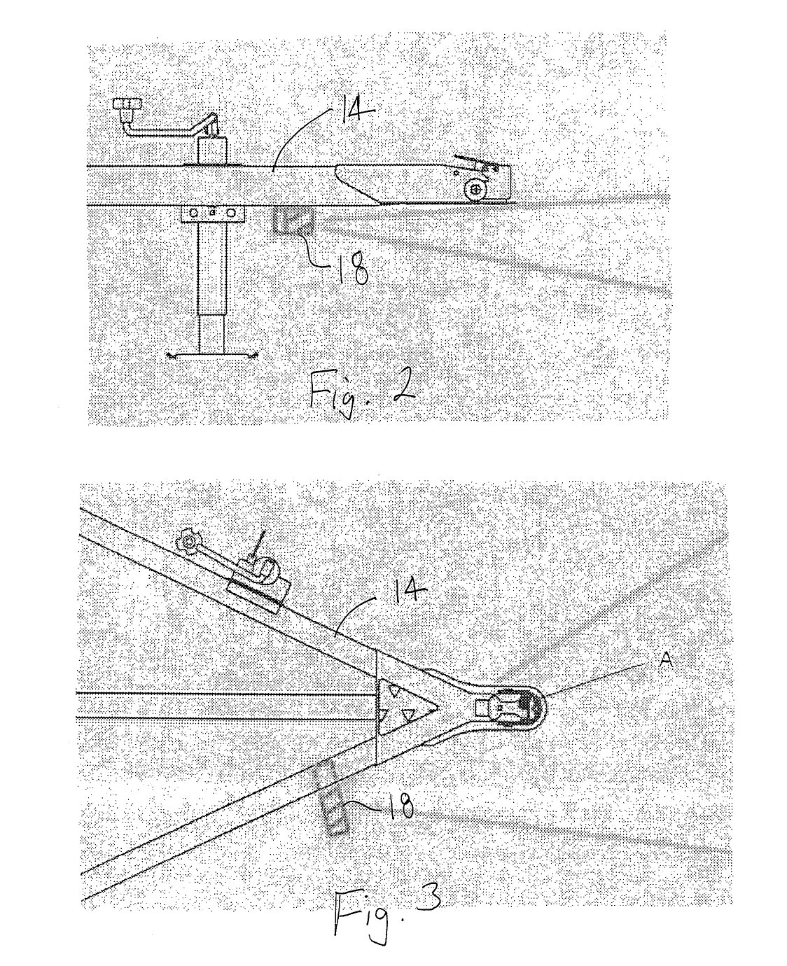

Referring now specifically to the drawings, and the illustrative embodiments depicted therein, a trailer alignment system 10 is illustrated for use with aligning a trailer hitch 14 of a trailer 11 with a vehicle hitch 16 of a vehicle 12 (FIG. 1). Trailer alignment system 10 includes a sensor 18 that is adapted to sense vehicle hitch 16, if sensor 18 is positioned at the trailer hitch, and to sense the trailer hitch if sensor 18 is positioned at the vehicle hitch. In the illustrative embodiment, sensor 18 is illustrated as positioned at the trailer hitch. This is a configuration that is particularly adapted for use in the aftermarket. In the OEM market, sensor 18 may be conveniently incorporated into the vehicle 12 and used to sense the trailer hitch.

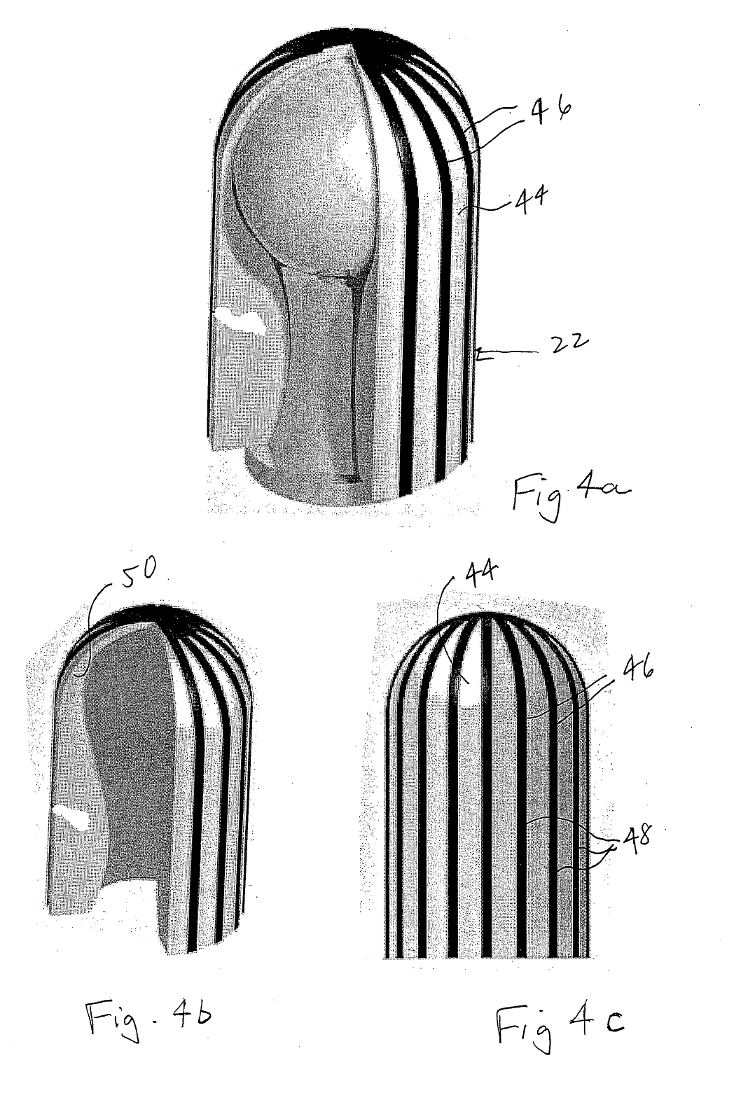

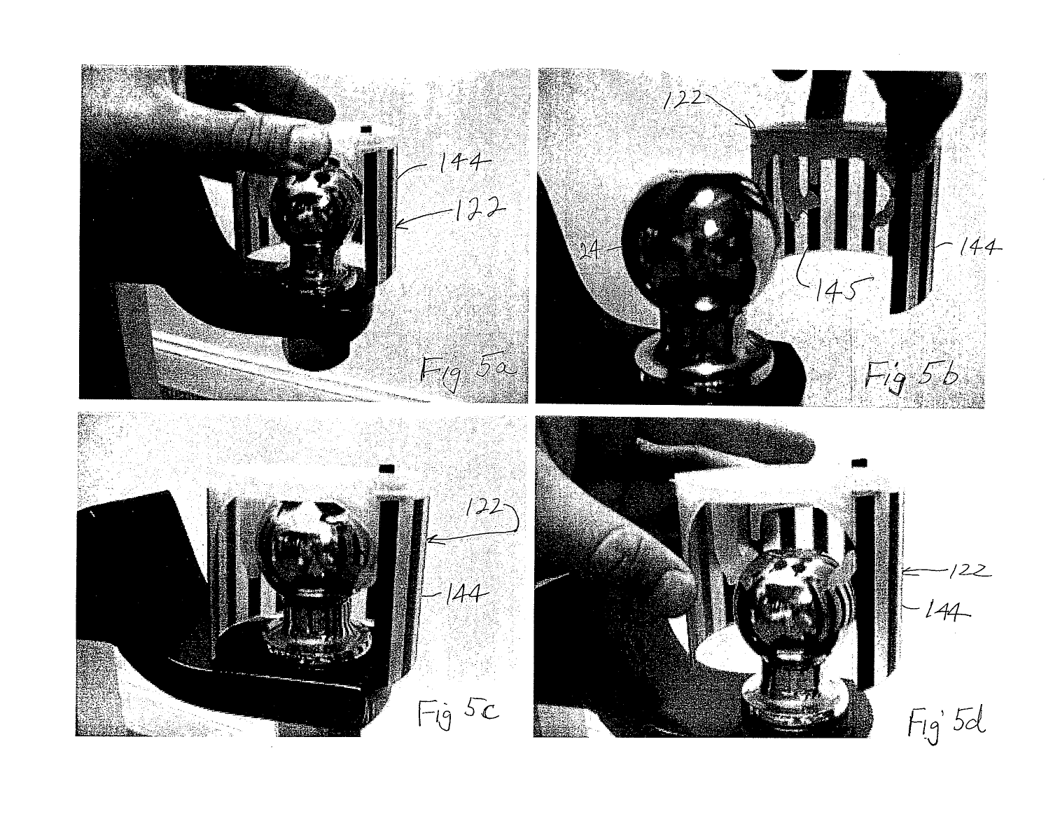

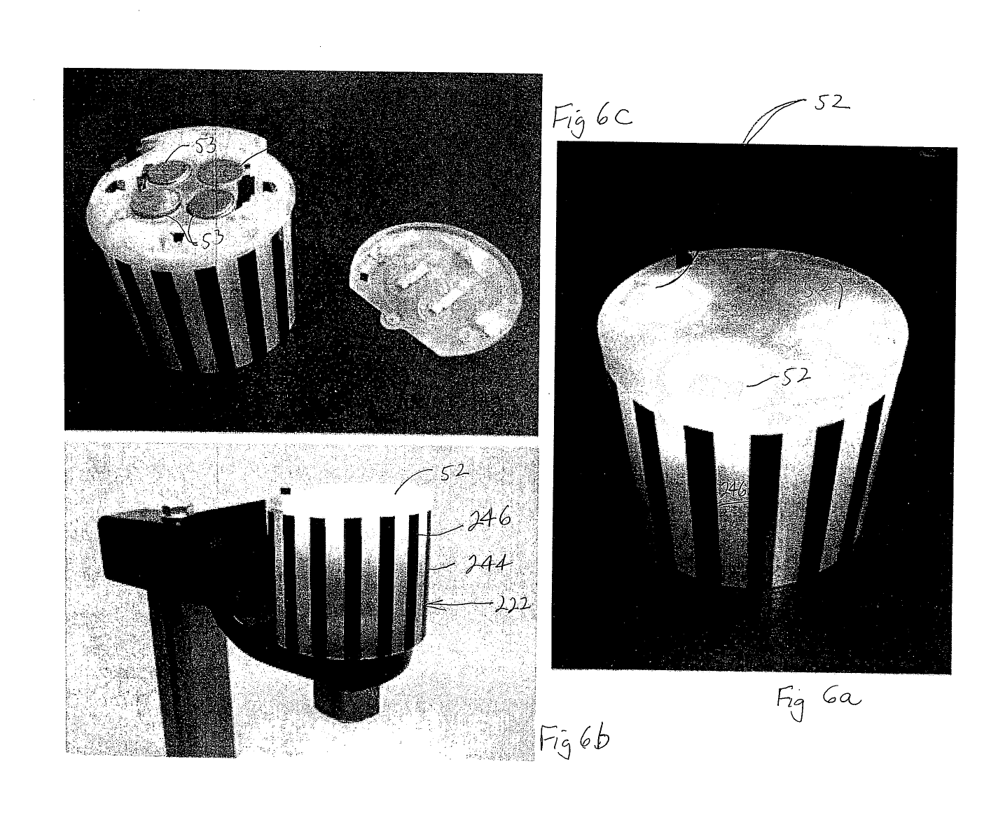

Trailer alignment system 10 may additionally include a driver interface module 20, which is positioned in the driver's cab in order to provide visual and/or audible signals to the driver. Alternatively, trailer alignment system 10 may provide steering commands directly to the vehicle steering system in order to automate the trailer alignment process. Trailer alignment system 10 may additionally include a visual target 22 which is configured to be applied to the hitch 16, 18 that is opposite to the hitch 16, 18 to which the sensor 18 is applied (FIGS. 4-6). In the illustrative embodiment, visual target 22 is configured to be temporarily applied to a structure, such a ball hitch 24, for the alignment process and removed after the alignment process, but prior to the engaging of the respective hitches 16, 18, as disclosed in commonly assigned United States Patent Application Publication No. US 2005/0285371 A1 published Dec. 29, 2005, by J. Edward Ramsey et al. entitled TRAILER ALIGNMENT DEVICE, the disclosure of which is hereby incorporated herein by reference.

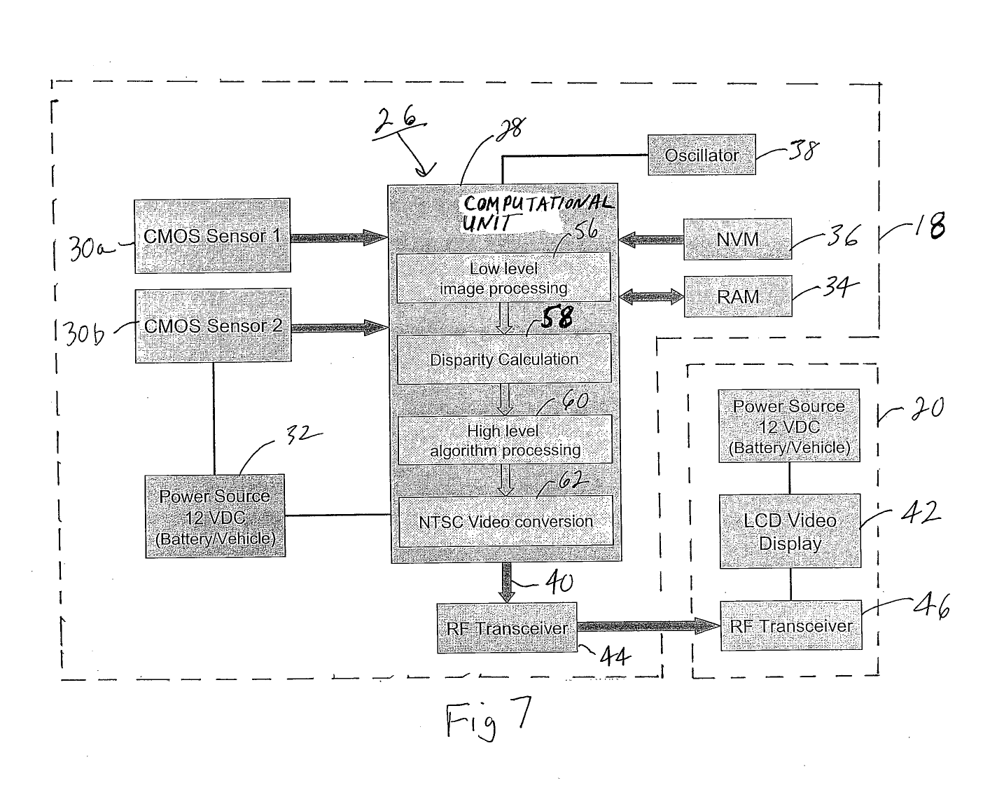

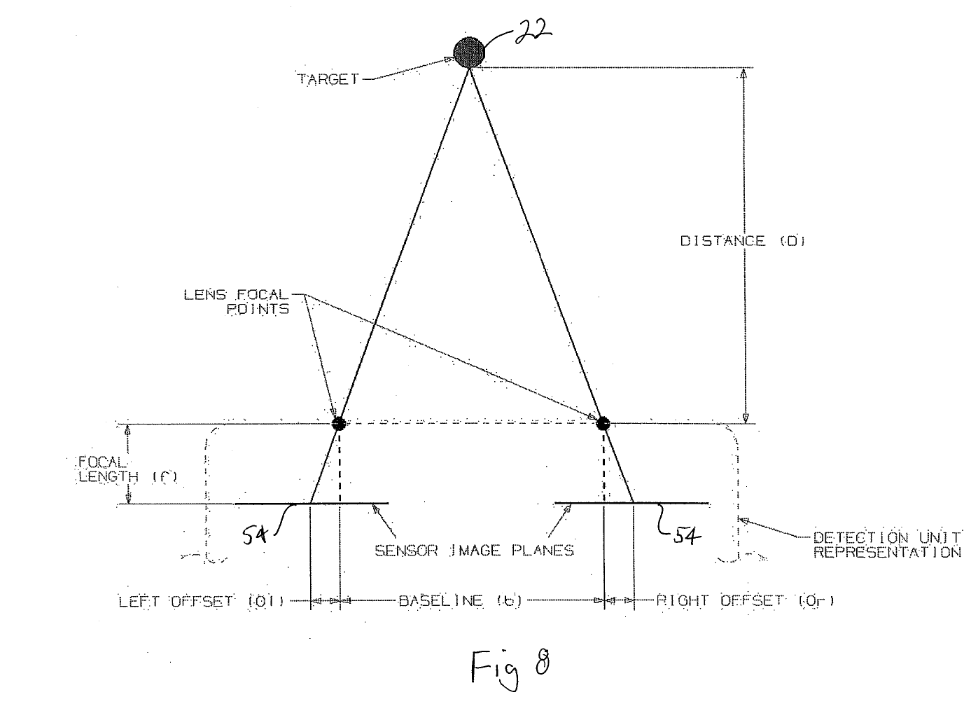

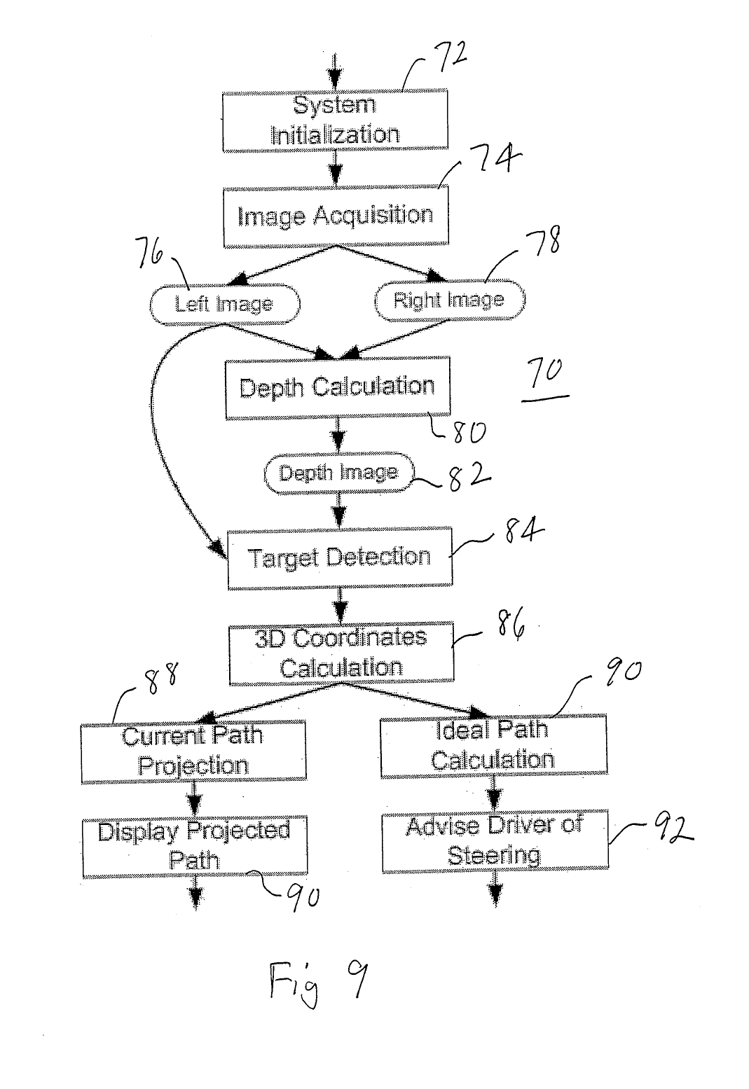

In the illustrative embodiment, sensor 18 is a camera system and, in particular, a stereoscopic-imaging system. As is known in the art, a stereoscopic-imaging system has two image sensors that are adapted to capturing at least two different images of a surface of an object at a distance. If stereoscopic-imaging system 18 is positioned at the trailer hitch, it captures an image of a surface at the vehicle hitch. If imaging system 18 is positioned at the vehicle hitch, it captures an image of a surface at the trailer hitch. In the illustrative embodiment, stereoscopic-imaging system 18 utilizes a commercially available digital stereo head of the type marketed by Videre Design Company. However, other stereoscopic-imaging techniques may be used. Stereoscopic-imaging system 18 additionally includes a control 26 having a computational unit, such as a processor 28 which processes digital images produced by two image sensors 30a, 30b that are at a fixed relationship to each other that allows the image sensors to capture stereoscopic images of the opposite hitch (FIG. 7). Computational unit 28, in the illustrative embodiment, is a digital signal processor of the type well known in the art that is available from various manufacturers, but may be a general purpose processor, an application specific integrated circuit, or the like. Computational unit 28 is provided with power, such as from a power source 32, which may be a vehicle battery connection, an internal battery, or other known power source. Computational unit 28 may additionally be provided with peripheral devices, such as a random access memory 34, a non-volatile memory 36, both of which are used for storing various program code and parameters used by the processor, and an oscillator 38 to provide a clock for the computational unit.

Computational unit 28 produces steering data at an output 40 that may be used to provide visual and/or audio information to a driver, such as using a video display 42 or speakers (not shown) that are part of driver interface module 20. Where sensor 18 is positioned at the trailer hitch, a communication channel, such as a wireless communication channel including an RF transceiver 44 at sensor unit 18 and RF transceiver 46 at the driver interface module, may be utilized for communication. Other wireless communication, such as infrared, Bluetooth, or the like, may also be used. Alternatively, communication signals may be modulated over the vehicle-to-trailer wiring bundle. Where sensor 18 is at the vehicle hitch, it is possible to connect driver interface module 20 with sensor 18 by wireless communication, hardwired communication, fiber optics, or the like.

Visual target 22 provides an assist for capturing of an image of the hitch opposite the hitch bearing sensor 18 in order to assist in determining the position of the hitch opposite sensor 18. As best seen by reference to FIGS. 4a-4c, visual target 22 includes a surface 44 having visual texture features 46 on the surface. In the illustrative embodiment, surface 44 wraps around a vertical axis of the target in a range of between approximately 180 degrees and 270 degrees for observation by sensor 18. In the illustrative embodiment, visual texture features 46 are defined by a series of two or more spaced apart vertical stripes 48. However, other visual texture features may be utilized. In the illustrative embodiment, vertical strips 48 converge at a top portion of visual target 22.

In an alternative embodiment illustrated in FIGS. 5a-5d, a visual target 122 includes a surface 144 defining texture features 146, such as vertical stripes that terminate below the top of the visual target. Target 122 has a flat top in order to have stripes that parallel throughout their entire length. Visual target 122 further includes an interior clip 145 that is configured to flexibly engaging the ball hitch 24. Clip 145 facilitates firm, but removable, retention of visual target 122 on the ball hitch. While clip 145 has an overall dome shape to directly engage the ball of the hitch, it could also be configured to engage other portions of the vehicle hitch, such as the neck of the ball hitch. In accordance with the principles set forth in commonly assigned United States Patent Application Publication No. US 2005/0285371 A1 published Dec. 29, 2005, by J. Edward Ramsey et al. entitled TRAILER ALIGNMENT DEVICE, the disclosure of which is hereby incorporated herein by reference, visual target 22, 122 may have an inner surface 50 having a domed portion in order to fit on ball hitch 24. Because the visual target is coincident with the ball hitch, sensor 18 is able to identify the position of the ball hitch by identifying the position of visual target 22, 122. However, visual target 22, 122 may be positioned elsewhere, such as on a vertical surface of vehicle 12 or trailer 11 with suitable compensation made for dimensional offset between the hitch feature, such as the ball hitch, the trailer hitch tongue, and the locations of the visual target and sensor.

In another alternative embodiment, a visual target 222 includes one or more light sources 52 in order to illuminate surface 244. By illuminating surface 244, the visual contrast provided by visual texture features 246 becomes greater. This may be particularly useful, by way of example, where visual target 222 is adapted to be positioned on ball hitch 24. As a visual imaging system, sensor 18 could, otherwise, be blinded by, for example, the vehicle's backup lights, which would be illuminated while the vehicle is backing up to position the trailer hitch and vehicle hitch together. By enhancing visual contrast, light source 52 allows the sensor to determine the position of visual target 222 even in the presence of the vehicle's illuminated backup lights, as well as other sources of visible noise, such as the lines of the vehicle, and the like. Light source 52 may be useful during daytime and nighttime conditions. Light source 52 may be a light-emitting diode (LED) source with a self-contained battery 53. Alternatively, the light source may be powered from the vehicle's battery and may be configured to be energized when the vehicle's backup lights are energized. Visual target 222 may include a wire bundle (not shown) having a connector which connects with a conventional trailer connector on vehicle 12. The connector on visual target 222 may be configured to plug into the conventional connector on the vehicle and provide for connection with the cable extending from the trailer 11. This would allow the light source 52 to receive power from the vehicle without requiring separate wiring of the visual target to the vehicle.

Other variations will be apparent to the skilled artisan. For example, rather than light source 52 being an internal light source, it could be an external light source directed onto visual texture features 246. Alternatively, light source 52 could be a reflector to reflect the backup lights of the vehicle, or other light source, toward the visual texture features of surface 44, 144, 244, or the like. Also, although visual target 22, 122, 222 is illustrated as a cylindrical shaped surface, it could be a flat surface or other three-dimensional shape. Also, it should be understood that visual texture features 46, 146, 246 may be applied directly to ball hitch 24, to a surface of vehicle 12, or to a surface of trailer 11.

Operation of sensor 18 may be understood by reference to FIG. 8 in which a pair of image sensors 54, which, in the illustrated embodiment, are CMOS low-noise high-sensitivity imagers that are packaged as a unit and are of the type commercially available and marketed by Videre Design Corporation. Processor 28 performs a disparity calculation based upon the baseline b, the focal length f of the imaging sensor and the offset O_{L} and Oᵣ between image pixels and the focal points using the following equation:
where D=bf/d,
where D is the distance to the target,
b is the baseline,
f is the focal length and
d is the difference between O_{L} and Oᵣ.

The disparity value can then be used to find which pixels correspond in the two images. One of the two images is typically considered to be the reference image. Pixels in the reference image have higher x coordinates than their corresponding pixels in their other image. The x coordinates correspond to lateral left-to-right locations. The y coordinates, which correspond to vertical dimensions, are the same for both images. The x coordinates are related by xᵣ and x_{L} minus 16d where disparities are specified in units of 1/16 pixels. Disparity calculations and determination of which pixels correspond in the two images is known in the art and is disclosed in detail in a publication entitled “SRI Small Vision System,” User's Manual, Software Version 4.2, published in February 2006 by SRI International, the disclosure of which is hereby incorporated herein by reference.

Computational unit 28 may be programmed with algorithms to carry out the object recognition illustrated in FIG. 8. A low-level image-processing algorithm 56 may provide some initial image processing on the output of image sensors 30a and 30b. This may include, by way of example, providing image windows, such as area correlation windows, and the like, as described in the Small Vision System publication referred to above. Once the low-level image processing is carried out, a disparity calculation algorithm 58 may be provided to perform the disparity calculation illustrated in FIG. 8 in order to determine the position of visual target 22. A high-level algorithm may be provided at 60 in order to determine steering data for causing the vehicle hitch to become aligned with the trailer hitch, as will be described in more detail below. In the illustrated embodiment having a video display 42, a video conversion algorithm 62 converts the steering data produced by algorithm 62 to a video format which is then transmitted by RF transceivers 44 and 46 to be displayed on video display 42.

Video produced by video conversion algorithm 42 may be of the type illustrated in FIG. 10 in which driver interface module 20 is illustrated as having a video display 42 that produces at a minimum a first indicia 64 which represents the location of visual target 22 which may be positioned at ball hitch 44. Second indicia 66 may be provided to represent the location of the other hitch, which, in the illustrative embodiment, is the trailer hitch. As vehicle 12 is moved towards the trailer, indicia 64 moves in the direction of indicia 66 as illustrated by the arrow in FIG. 10. Indicia 64 and indicia 66 provide a representation of the vehicle hitch and the trailer hitch as viewed from above. This provides a “birds-eye” view of the alignment process in order to be intuitive to the driver when attempting to move indicia 64 to be coincident with indicia 66 whereby the vehicle hitch will be aligned with the trailer hitch. In addition, driver interface module 20 may include driver feedback, such as one or more speakers or other feedback device, in order to produce a beep or other sound or indication when the indicia 64 lines up with indicia 66 to alert the driver to the aligned condition. The driver interface module may include various input devices, such as selector switches 68, which may be mechanical switches, soft keys, or the like. Alternatively, the driver interface module may be equipped to respond to voice commands. Display 42 may be a liquid crystal display (LCD) screen, a light-emitting diode (LED) display screen, a cathode ray tube (CRT) display screen, a quartz display screen, a touch screen display screen, a plasma display screen, or the like. For example, display 42 may be a LED type display screen with a plurality of LEDs forming the display screen, such as 600 LEDs across by 1024 LEDs down. Moreover, magnification overlays may be added to enlarge the screen to ease viewing. While display 42 is illustrated as a dedicated unit, its function may be incorporated in a multi-function display incorporated into the dashboard of the vehicle.

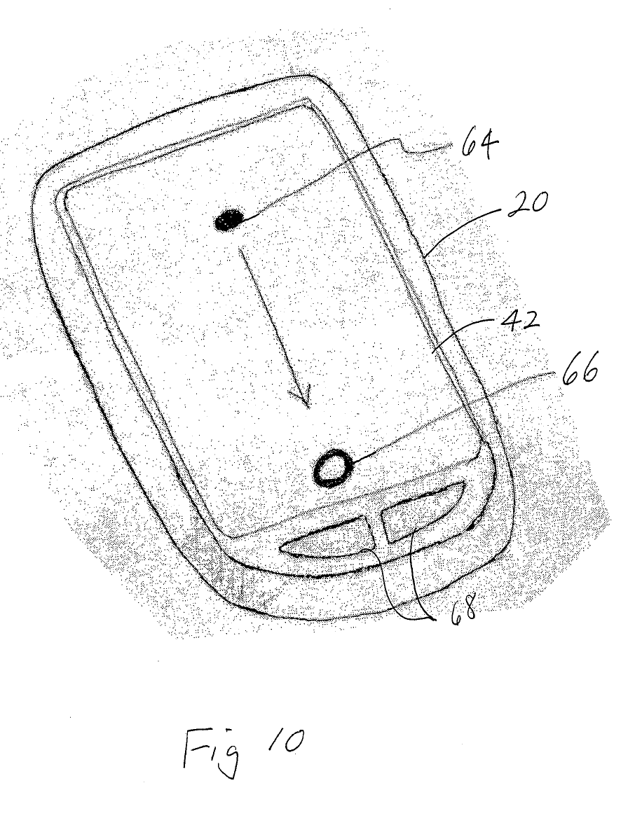

A process 70 carried out by digital signal processor 28 to produce steering data begins at 72 with system initialization (FIG. 9). Once the system is initialized, control 26 will attempt to acquire an image of visual target 22 at 74 and will obtain a left image 76 with one of the image sensors 54 and a right image 78 with the other image sensor 54. The processor will then perform a depth calculation at 80 in order to determine a distance to the visual target in the form of a depth image 82. The processor will also produce three-dimensional coordinates of the visual target by detecting the target at 84 and carrying out three-dimensional coordinate calculations at 86 utilizing the formula previous set forth.

Once the coordinates of the position of visual target 22 have been obtained at 86, a projection of the anticipated path of vehicle trailer hitch is made at 88 and displayed with video display 42 at 90. Current path projection algorithms are known in the art. An example includes the backup system utilized with the commercially availably Lexus LS 460 vehicle marketed by Toyota. The processor also determines an ideal path at 90, which would be an optimal path to direct the vehicle hitch toward the trailer hitch, and provide steering data at 92. The steering data may be advised to the driver, such as audible commands (“turn left,” “turn right”) or by the display of a path with video display 42. Examples of ideal path calculations are known in the art and are within the knowledge of the skilled artisan.

The use of stereoscopic imaging allows the trailer alignment system to provide data to the driver and/or the vehicle to guide the vehicle hitch toward the trailer hitch at a greater distance than is known with prior systems and to do so in a more accurate manner. Also, it may do so in an intuitive manner that assists the driver in moving the vehicle, which is typically in reverse gear, to cause the vehicle hitch to become aligned with the trailer hitch. This is accomplished in a manner that may be incorporated into the vehicle for OEM applications or may be marketed as an aftermarket application. The use of a visual target having visual texture features facilitates object recognition to enhance the ability of the system to calculate the location of the target position opposite the sensor or detection unit.

The use of a visual target, which may be in the form of a cap to fit over the ball hitch of the vehicle hitch, provides a device that may be applied to the vehicle when in use and removed for connection of the hitches thereby allowing the visual target to be stored away from the elements when not in use. Also, the ability in certain embodiments to internally illuminate the visual target facilitates the ability to distinguish the visual target in the presence of, for example, vehicle backup lights which will be illuminated during the trailer alignment process, as well as other sources of visible noise, such as the lines of the vehicle, and the like.

The trailer alignment system disclosed herein may include a display that is user friendly and relates the positioning between the vehicle hitch and the trailer hitch coupler as the vehicle moves towards the trailer. The driver interface module may be mounted inside the vehicle or held by the driver. An RF transceiver may be incorporated into the display and the sensor unit to transmit data wirelessly from the sensor unit and display the data on the video display. The display may show the positioning in a “birds-eye” view with each trailer hitch being depicted as either a dot or a circle. However, other embodiments may include other shapes. On the display, the trailer hitches will be oriented in a vertical relationship with the trailer coupler icon located at the bottom of the display in a stationary position and the vehicle hitch icon located at the top of the display. The top indicia will move in a vertical direction downwardly as the vehicle moves closer to the trailer. This alignment will be displayed by the incorrect path that the vehicle hitch indicia, or icon, takes on the display as it nears the trailer hitch icon. Once the dot is positioned inside the circle, the representation demonstrates that the ball hitch is located under the trailer hitch coupler such that the coupler can be lowered onto the ball hitch once a visual target is removed from the ball hitch. Upon alignment, an audible or visual acknowledgement of alignment may be generated by driver interface module 20.

Changes and modifications in the specifically described embodiments can be carried out without departing from the principles of the invention which is intended to be limited only by the scope of the appended claims, as interpreted according to the principles of patent law including the doctrine of equivalents.

1. An electronic trailer hitch alignment system for assisting a driver in aligning a vehicle hitch with a trailer hitch, said alignment system comprising:
a stereoscopic-imaging system that is adapted to be positioned at one of the vehicle hitch or the trailer hitch, said imaging system comprising at least two image sensors, said at least two image sensors being adapted to capturing at least two different images of a surface at the other of said vehicle hitch or the trailer hitch;
a processor, said processor determining position data from the at least two different images of the surface at the other of said vehicle hitch or said trailer hitch, wherein the position data defines a position of the other of said vehicle hitch or said trailer hitch with respect to the one of said vehicle hitch or said trailer hitch; and
a steering unit that is responsive to the position data for determining steering data, the steering data causing the vehicle hitch to approach the position of the trailer hitch.

2. The trailer alignment system as claimed in claim 1 wherein said steering unit comprises a driver interface module, said driver interface module providing instruction to the driver to cause the vehicle hitch to approach the position of the trailer hitch.

3. The trailer alignment system as claimed in claim 2 wherein said processor includes a path planning algorithm, said path planning algorithm determining a planned path between the vehicle hitch and the trailer hitch.

4. The trailer alignment system as claimed in claim 3 wherein said process includes an anticipated path algorithm, said anticipated path algorithm determining an anticipated path of the vehicle and wherein said processor provides the steering data as a function of the anticipated path of the vehicle and the planned path of the vehicle.

5. The trailer alignment system as claimed in claim 2 wherein said driver interface module includes a visual display, said visual display displaying icons of the vehicle hitch and the trailer hitch as viewed from above the vehicle and the trailer.

6. The trailer alignment system as claimed in claim 2 wherein said driver interface module includes a speaker, said speaker providing audible steering commands to the driver.

7. The trailer alignment system as claimed in claim 2 wherein said imaging system is adapted to be positioned at the trailer hitch and said driver interface is adapted to be positioned within the vehicle and comprising a wireless communication link between said imaging system and said driver interface.

8. The trailer alignment system as claimed in claim 1 wherein the surface at the other of said vehicle hitch or the trailer hitch comprises a visible target that is adapted to be positioned at the other of said vehicle hitch or the trailer hitch, wherein said imaging system obtains the at least two different images as images of said visible target.

9. The trailer alignment system as claimed in claim 8 wherein said imaging system is adapted to be positioned at the trailer hitch and said visible target is adapted to be positioned at the vehicle hitch.

10. The trailer alignment system as claimed in claim 9 wherein said vehicle hitch comprises a ball hitch having a ball and wherein said visible target is adapted to be removeably positioned over the ball.

11. The trailer alignment system as claimed in claim 8 including an illumination source at said visible target wherein said imaging system is adapted to further distinguish said visible target.

12. The trailer alignment system as claimed in claim 8 wherein said visible target comprises visible surface features.

13. The trailer alignment system as claimed in claim 12 wherein said visible surface features comprise stripes.

14. The trailer alignment system as claimed in claim 1 wherein said imaging system capturing at least two different images of the surface in a visible light spectrum.

15. The trailer alignment system as claimed in claim 1 wherein said at least two image sensors comprise scanning sensors.

16. The trailer alignment system as claimed in claim 1 wherein said at least two image sensors comprise digital cameras.

17. The trailer alignment system as claimed in claim 1 wherein said processor includes a disparity algorithm, said disparity algorithm compares the at least two different images and generates a disparity image.

18. The trailer alignment system as claimed in claim 17 wherein said disparity algorithm comprises an area based correlation matching algorithm.

19. The trailer alignment system as claimed in claim 17 wherein said processor calculates the position data as a function of the disparity image.

20. The trailer alignment system as claimed in claim 1 wherein said processor calculates the position data as a function of focal length of said at least two image sensors and distance between said at least two image sensors.

21. The trailer alignment system as claimed in claim 20 wherein said processor calculates the position data as a function of distance between said at least two image sensors and said one of the vehicle hitch or the trailer hitch.

22. A method of assisting a driver in aligning a vehicle hitch with a trailer hitch, said method comprising:
providing a stereoscopic-imaging system and positioning said imaging system at one of the vehicle hitch or the trailer hitch, said imaging system comprising at least two image sensors;
capturing at least two different images of a surface at the other of said vehicle hitch or the trailer hitch with said at least two image sensors;
determining position data from the at least two different images of the surface at the other of said vehicle hitch or said trailer hitch, wherein the position data defines a position of the other of said vehicle hitch or said trailer hitch with respect to the one of said vehicle hitch or said trailer hitch; and
determining steering data that will cause the vehicle hitch to approach the position of the trailer hitch.

23. The method as claimed in claim 22 including providing instruction to the driver to cause the vehicle hitch to approach the position of the trailer hitch.

24. The method as claimed in claim 23 wherein including determining a planned path between the vehicle hitch and the trailer hitch.

25. The method as claimed in claim 24 including determining an anticipated path of the vehicle and providing the steering data as a function of the anticipated path of the vehicle and the planned path of the vehicle.

26. The method as claimed in claim 23 including displaying icons of the vehicle hitch and the trailer hitch as viewed from above the vehicle and the trailer.

27. The method as claimed in claim 23 including providing audible steering commands to the driver.

28. The method as claimed in claim 22 further including providing a visible target that defines the surface at the other of said vehicle hitch or the trailer hitch including obtaining the at least two different images as images of said visible target.

29. The method as claimed in claim 28 including positioning said imaging system at the trailer hitch and said visible target at the vehicle hitch.

30. The method as claimed in claim 29 wherein said vehicle hitch comprises a ball hitch having a ball and including removeably positioning said visible target over the ball.

31. The method as claimed in claim 28 including illuminating said visible target to further distinguish said visible target.

32. The method as claimed in claim 28 wherein said visible target comprises visible surface features.

33. The method as claimed in claim 32 wherein said visible surface features comprise stripes.

34. The method as claimed in claim 22 including capturing at least two different images in a visible light spectrum.

35. The method as claimed in claim 22 wherein said at least two light image sensors comprise scanning sensors.

36. The method as claimed in claim 22 wherein said at least two image sensors comprise digital cameras.

37. The method as claimed in claim 22 including comparing the at least two different images and generating a disparity image from the comparing.

38. The method as claimed in claim 37 wherein said comparing includes performing an area based correlation matching.

39. The method as claimed in claim 37 including calculating the position data as a function of the disparity image.

40. The method as claimed in claim 22 including calculating the position data as a function of focal length of said at least two image sensors and distance between said at least two image sensors.

41. The method as claimed in claim 40 including calculating the position data as a function of distance between said at least two image sensors and said one of the vehicle hitch or the trailer hitch.

42. The method as claimed in claim 22 wherein including determining a planned path between the vehicle hitch and the trailer hitch.

43. The method as claimed in claim 42 including determining an anticipated path of the vehicle and providing the steering data as a function of the anticipated path of the vehicle and the planned path of the vehicle.

44. The trailer alignment system as claimed in claim 1 wherein said processor includes a path planning algorithm, said path planning algorithm determining a planned path between the vehicle hitch and the trailer hitch.

45. The trailer alignment system as claimed in claim 44 wherein said process includes an anticipated path algorithm, said anticipated path algorithm determining an anticipated path of the vehicle and wherein said processor provides the steering data as a function of the anticipated path of the vehicle and the planned path.
